(19) United States
(12) Patent Application Publication
(10) Pub. No.: US 2005/0234819 A1
(43) Pub. Date: Oct. 20, 2005

(54) Account transfer process instructing method and apparatus

(75) Inventors: Takehiro Ueno, Yokohama (JP); Hiroaki Kobayashi, Yokohama (JP); Shinichiro Inoue, Kawasaki (JP); Yuuichi Nomura, Yokohama (JP); Hirofumi Iiduka, Kawasaki (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 11/000,880

(22) Filed: Dec. 1, 2004

(30) Foreign Application Priority Data
Apr. 16, 2004 (JP) 2004-121007

(51) Int. Cl. G06F 17/60

(52) U.S. Cl. 705/40

(57) ABSTRACT

An account transfer process instructing system uses payment request information issued from a payment request institution device that performs payment requests to the user to thereby process authentication of the person in question. When a payment instruction is made by the user, the account transfer process instructing system executes transfer processings to transfer payments from the user's bank accounts to an account of the payment request institution.

### BACKGROUND OF THE INVENTION

1. Field of the Invention

The present invention relates to technologies that realize fund transfer processings through a network.

2. Description of the Related Arts

A settlement system that enables transferring funds for compensation of various services including public utility charges, etc between accounts is shown in JP-A-2001-243403. According to such a settlement system, a center system is connected with member terminals used by the members, a member company system and financial institutions. The center system divides transfer request data received from the member company system to destination financial institutions based on the transfer request data, and sends the transfer request data to the respective financial institutions.

According to another example of a fund transfer processing system is shown in JP-A-2001-331646. Even when a portal site that relays information among financial institutions or among users' terminals and financial institutions does not manage users' information, payments can be sent to administrative bodies, etc. based on authentication made by a public authentication station that manages user authentication information data.

According to the second technology, the user, after being identified by the public authentication station, uses the user terminal to send his/her identification certificate to the portal site, and the portal site confirms its authenticity. After authentication, the portal site sends the user's identification and certification to an administrative body's terminal, and the administrative body's terminal searches a database based on the user's identification and certification, and sends registration information about the user to the portal site. After making a management ledger, the portal site presents the management ledger to the user terminal. The user terminal sends to the portal site a payment request including the payment amount, withdrawal account information, and transfer destination account information. The portal site sends the payment request information to a financial institution, and a terminal at the financial institution processes the payment.

According to the first technology, it is necessary for each member to register in the center system as a prerequisite for using the transfer service, and this causes a problem in that users who want to use service are limited. Moreover, the center system is placed under a heavy load of managing the users' registration information.

According to the second technology, when a payment is made to an administrative body, the portal site makes authentication of the user based on certification by the public authentication station, and then sends the user ID and certification to the administrative body, and the administrative body searches the database based on the user ID and certification, and sends the search result to the portal site. Therefore, it is necessary to use the portal site to acquire user's registered information from the administrative body. Connecting to the administrative body after an authentication confirmation is made based on information from the public authentication station imposes much processing load on the portal site. Moreover, the portal site is placed under a substantial processing load because the portal site communicates with users' terminals, the public authentication station, terminals at administrative bodies and financial institutions.

### SUMMARY OF THE INVENTION

The present invention relates to a technology with which, when a payment is to be made to an administrative body, any user who has made user's authentication confirmation with a payment request (or a bill) issued by the administrative body, and has the payment request issued by the administrative body, can receive service for transferring the payment to the administrative body even when the user is not a member previously registered to receive prescribed service.

In accordance with an embodiment of the present invention, an account transfer instruction processing system uses payment information issued from a payment institution device that performs payment requests to users to thereby process authentication of the users. In one aspect, an account transfer instruction processing system includes an authentication institution device that performs authentication of users. When the user is authenticated by the authentication institution device, the payment institution device transmits payment request information upon receiving the result of authentication from the authentication institution device.

As a result, even when the user is not a registered member who has beforehand registered with a relay device to receive prescribed service, the system in accordance with the present embodiment allows the user to process payments based on payment information issued from the payment institution device while the processing load on the relay device is suppressed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Preferred embodiments of the present invention will now be described in conjunction with the accompanying drawings, in which:

FIG. 1 schematically shows a system structure;

FIG. 2 shows information stored in an IC card;

FIG. 3 shows data bases that may be maintained at an authentication device 2 and a payment request institution device 3, respectively;

FIG. 4 shows data bases maintained at a relay device 4, a financial institution device 5, and a tax receiving agent 6, respectively;

FIG. 5 is a flowchart of processings executed in accordance with an embodiment of the present invention;

FIG. 6 is a flowchart of processings executed in accordance with an embodiment of the present invention;

FIG. 7 is a flowchart of processings executed in accordance with an embodiment of the present invention; and

FIG. 8 is flowchart of processings executed in accordance with another embodiment of the present invention.

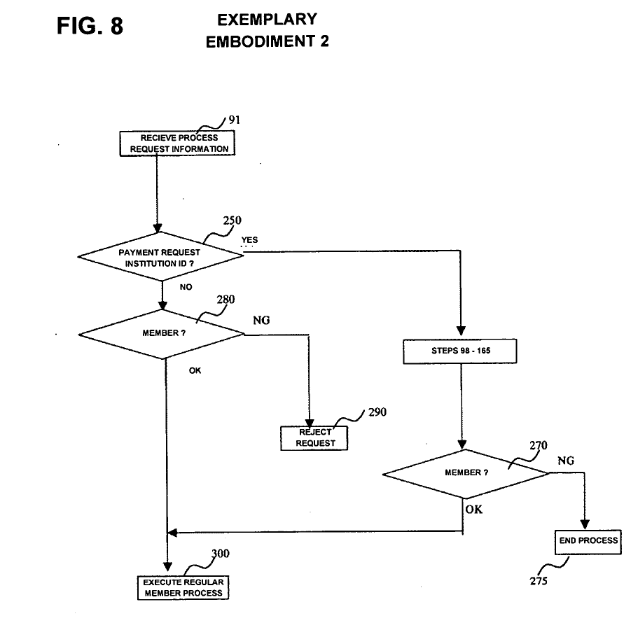

### DESCRIPTION OF THE PREFERRED EMBODIMENTS

Preferred embodiments of the present invention are described below with reference to the accompanying drawings.

### Exemplary Embodiment 1

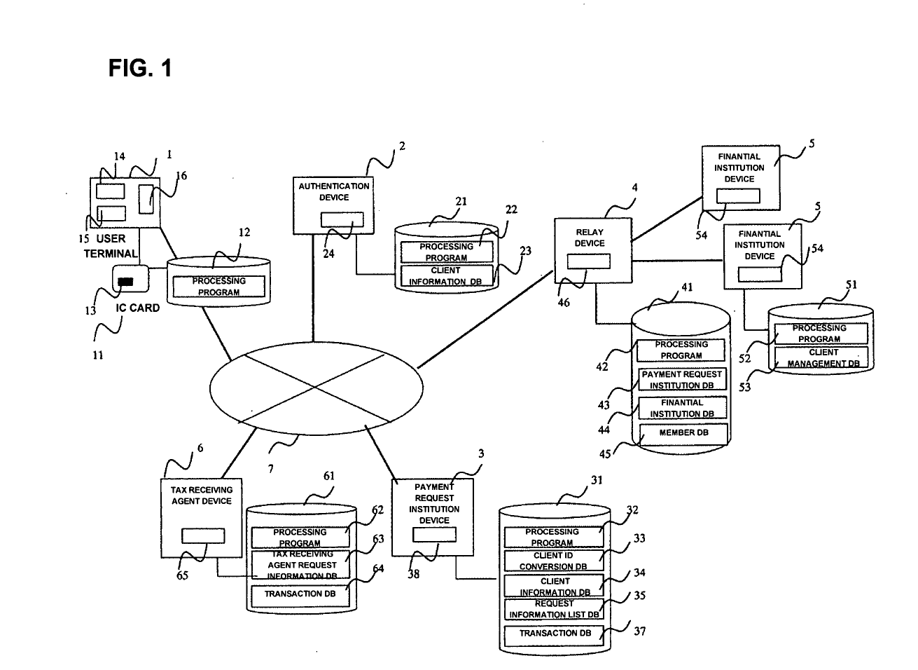

A system in accordance with a first exemplary embodiment of the present invention concerns processings to be performed when the user pays a requested amount to a payment request institution. FIG. 1 shows a system configuration of the present exemplary embodiment. The system may include a user terminal 1 that may be operated by users, an authentication device 2 that authenticates the users, and sends information from the user terminal 1 to a payment request institution device 3, a payment request institution device 3 of a payment request institution that requests the users to make payments of billed amounts, a relay device 4 that relays information to financial institution devices 5, and a tax receiving agent device 6 of a tax receiving agent that requests the users to pay billed amounts, which can be mutually communicated through a network 7. The tax receiving agent is an institution that transmits or sends payment requests to the users, and accepts payments with payment requests that the users retain. The payment request institution refers to an institution that maintains payment requests. Further, the relay device 4 may be connected to a plurality of financial institution devices 5 through the network. In this system, the financial institution device 5 executes processings to transfer requested payments from, for example, a user account maintained by the user to a payment request institution account and/or a tax receiving agent device account maintained by the payment request institution and/or the tax receiving agent, respectively.

The user terminal 1 may be equipped with a display device 14, an input device 15 and a processor 16. The authentication device 2 is equipped with a processor 24. The payment request institution device 3 is equipped with a processor 38. The relay device 4 is equipped with a processor 46. The tax receiving agent 6 is equipped with a processor 65.

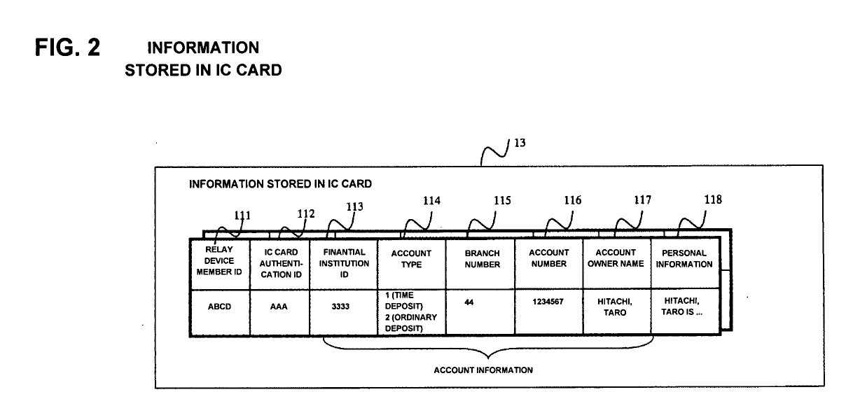

FIG. 2 shows an example of data stored in a storage device 13 of an IC card 11. Each user maintains the IC card. The present exemplary embodiment starts when the input device 15 of the user terminal 1 accepts information stored in the storage device 13 of the IC card.

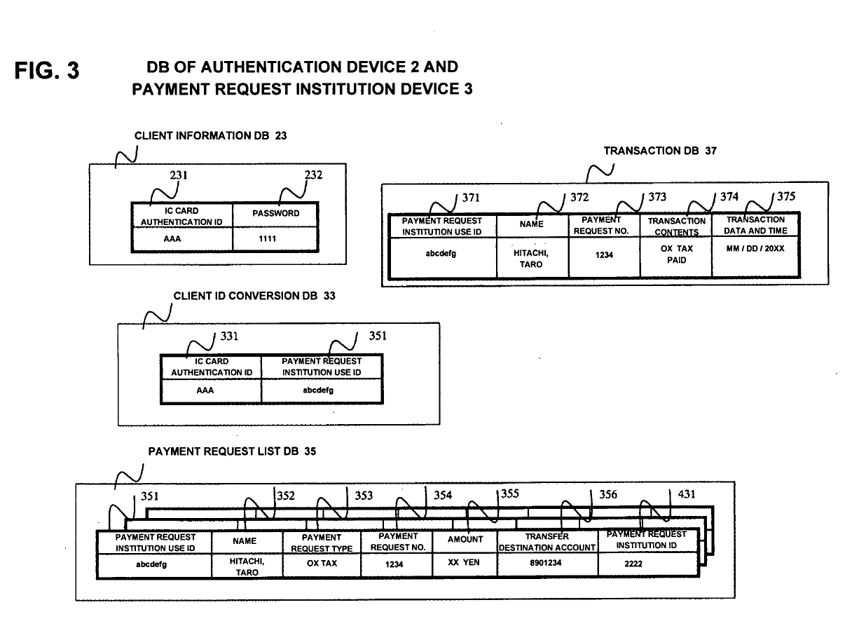

FIG. 3 shows an example of the structure of data stored in an authentication DB 21 (hereafter, a data base is abbreviated as a DB) to which the authentication device 2 can be connected, and an example of the structure of data stored in a payment request institution DB31 to which the payment request institution device 3 can be connected.

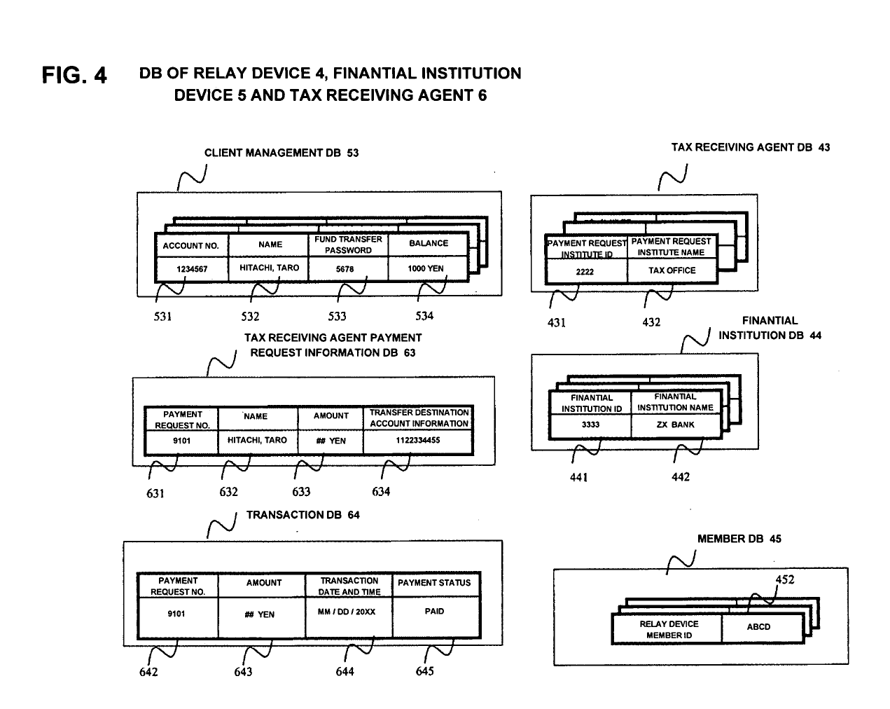

FIG. 4 shows examples of the structures of data stored in a relay device DB 41 to which the relay device 4 can connect, a financial institution DB 51 to which the financial institution device 5 can connect, and a tax receiving agent device DB 61 to which the tax receiving agent device 6 can connect, respectively.

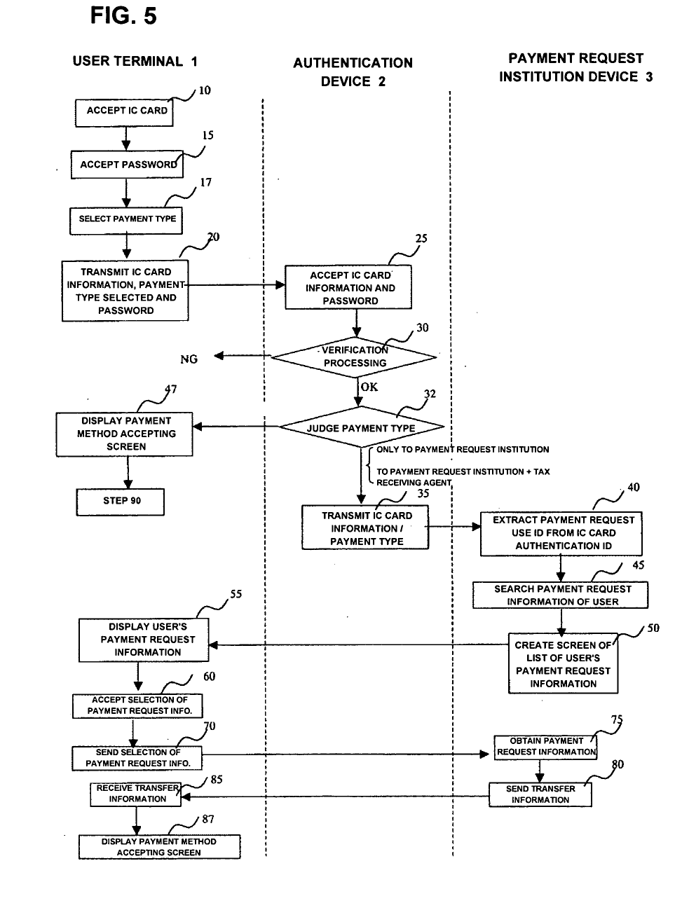

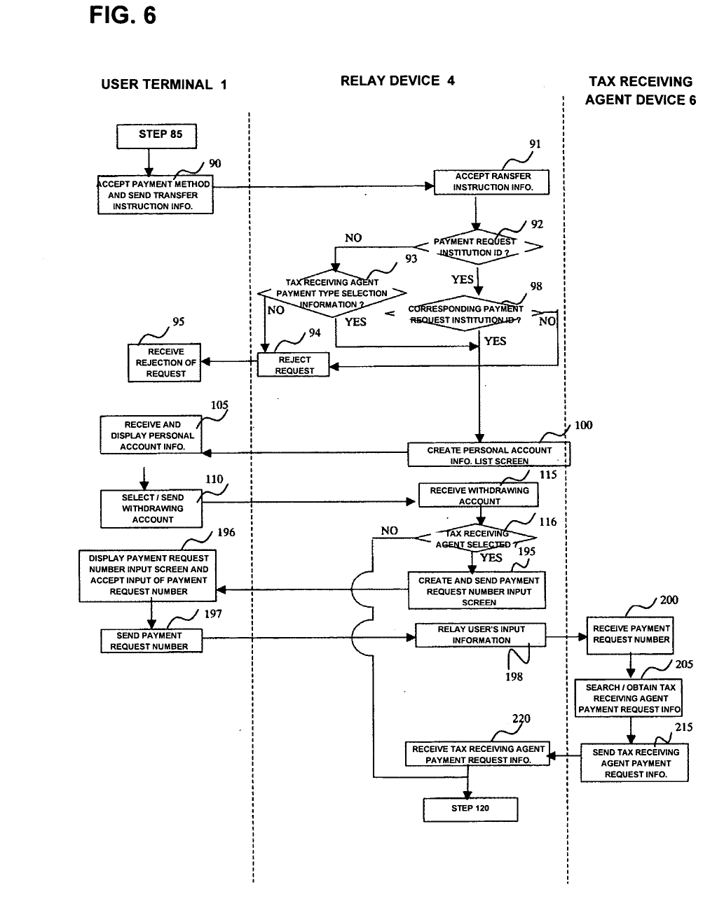

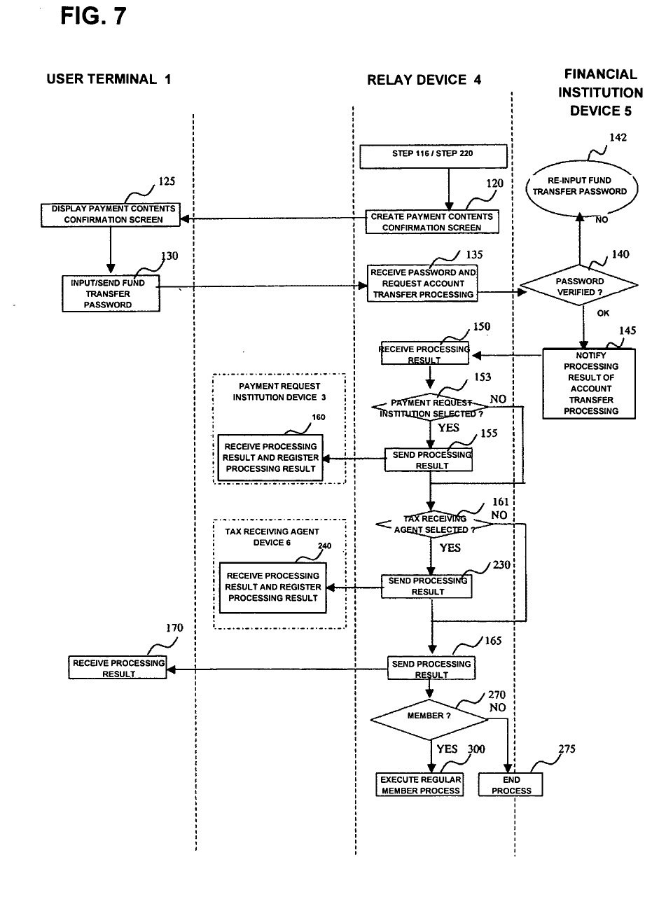

FIG. 5, FIG. 6 and FIG. 7 are flowcharts of processings executed when the user terminal 1 that is used by the user who wants to make a payment to the payment request institution and/or the tax receiving agent transmits user's information to the payment request institution device 3, the payment request institution device 3 retrieves user's payment request information, and the relay device 4 judges whether a transfer processing is possible based on the payment request information, and instructs the financial institution device 5 to transfer the billed amount. The user terminal 1, the authentication device 2, the payment request institution device 3, the relay device 4, the financial institution device 5, and the tax receiving agent device 6 execute with their respective processing devices (16, 24, 38, 46, 54, 65) processings according to processing programs stored in the DBs connectable by the respective processing devices (the authentication DB 21, the payment request institution DB 31, the relay device DB 41, the financial institution DB 51, and the tax receiving agent DB 61).

In step 10, the user terminal 1 accepts, at its input device 15, an IC card authentication ID 112, a financial institution ID 113, an account type 114, a store number 115, an account number 116, an account holder name 117, and private information 118 stored in the storage device 13 of the IC card 11. The IC card authentication ID 112 is an identifier that is given to each card and identifies the user who maintains the card. The financial institution ID 113, account type 114, store number 115, account number 116, and account holder name 117 are account information that indicates information on the account that the user maintains. When the user has a plurality of accounts, a plurality of account information is stored.

The financial institution ID 113 is an identifier that the user identifies a financial institution of the account, and can identify the financial institution device 5 in this exemplary embodiment. The account type 114 indicates the kind of each money product, such as, for example, ordinary deposit account, checking account, etc. The store number 115 is an identifier that indicates a branch of the financial institution to which the account belongs. The account number 116 is an identifier that identifies the account maintained by the user. The account holder name 117 is the name of the contractor who maintains the account. The private information 118 is, for example, information on the account holder name 117 such as user's address, etc. It is noted that the account type 114, the store number 115, and the account number 116 are assumed to be personal bank account information for the convenience of the description.

In step 15, the user terminal 1 accepts an input of a password from the user. It is noted here that the password is a password stored in the authentication device 2 that is used to confirm the validity of the user. In step 17, the user terminal 1 accepts a selection of the payment type. The selection of the payment type is to accept selection of either the payment only to the payment request institution, the payment to both of the payment request institution and the tax receiving agent, or the payment only to the tax receiving agent. In step 20, the user terminal 1 transmits the IC card authentication ID 112, the password, and the selected payment type to the authentication device 2.

In step 25, the authentication device 2 receives the IC card authentication ID 112, the password, and the payment type. In step 30, the authentication device 2 searches a client information DB 23 that stores, as client's information, IC card authentication IDs 231 that are given to corresponding IC cards that the users maintain and passwords 232 associated with the IC card authentication IDs 231, respectively, and retrieves client's information with which the IC card authentication ID 112 and the password received match with any of the IC card authentication IDs 231 and passwords 232 stored. When matching client's information is not found, information indicating that client's information has not been found is sent to the user terminal 1, and the process ends. The process proceeds to step 32 when the client's information is retrieved. In step 32, the authentication device 2 judges the payment type. The process proceeds to step 47 in the case of payment only to the tax receiving agent. The process proceeds to step 35 in the case of payment only to the payment request institution or payment to both of the payment request institution and the tax receiving agent. In step 47, the user terminal 1 displays a screen for accepting a selection of payment method. For example, payment by account transfer, electronic money, or cash may be enumerated as the payment method. The process proceeds to step 90. In step 35, the authentication device 2 sends the IC card authentication ID 112 to the payment request institution device 3.

In step 40, the payment request institution device 3 receives the IC card authentication ID 112, searches a client ID conversion DB 33, retrieves an IC card authentication ID 331 corresponding to the received IC card authentication ID 112, and extracts a payment request institution use ID corresponding to the IC card authentication ID 112 from a payment request institution use ID entry field 351. It is noted here that the conversion process in step 40 is a process that is conducted when the payment request institution stores and manages client information of users who use the payment request institution stored in a payment request information list DB 35 with payment request institution use IDs that are IDs different from the IC card authentication ID 331. When payment request information, etc. are stored and managed with the IC card authentication IDs 331, step 40 does not need to be conducted. In this case, the payment request institution use ID in the following description is to be read as the integrated circuit card authentication ID 331. In step 45, payment request information with a payment request institution use ID corresponding to the payment request institution use ID retrieved in step 40 is retrieved from the payment request institution use ID entry field 351 in the payment request information list DB35. The payment request information list DB 35 stores payment request information including, for each payment request number 354 that is given for each payment request information and is an identifier that identifies the payment request information, a payment request institution use ID 351, a name 352 of the user to whom the payment request institution use ID is given, a payment request type 353, an amount 355 that is a requested payment amount, a transfer destination account 356 that is an account that the payment request institution maintains, and is a transfer destination of the requested payment amount, a payment request institution ID 431 that identifies the payment request institution. When there are two or more payment request information with which the payment request institution use ID 351 matches, these plural payment request information is retrieved. Also, in step 20, the user terminal 1 also transmits the account holder name 115. In step 45, the payment request institution device 3 may compare the account holder name 115 and the name 352 to check the validity.

In step 50, the payment request institution device 3 creates a list of payment request information that may include payment request numbers 354, payment request types 353, and amounts 355 base on the payment request information retrieved in step 45. Here, the list of payment request information is a list to make the user to select request information for which the user wants to make payment. The payment request type 353 and the amount 355 are information to be displayed for the purpose of facilitating the user's selection, and other information concerning the payment request type 353 and the amount 355 may be included in the list of payment request information, or the payment request type 353 and the amount 355 may not be included in the list, so long as the purpose is accomplished.

In step 55, the user terminal 1 receives and displays the list of payment request information. In step 60, the user terminal 1 accepts a selection of payment request information for which payment processing is to be conducted from the list of payment request information displayed. In step 70, the user terminal 1 sends a payment request number 354 of the selected payment request information to the payment request institution device 3.

In step 75, the payment request institution device 3 receives the payment request number 354. The payment request institution device 3 picks up payment request information with a payment request number corresponding to the received payment request number 354 from among the payment request information retrieved in step 45. In step 80, the payment request institution device 3 sends to the user terminal 1, at least, a payment request number 354, an amount 355 that the user is requested to pay, a transfer destination account 356 and a payment request institution ID 431, as transfer information.

In step 85, the user terminal 1 receives the transfer information. In step 87, the user terminal 1 displays a screen to accept selection of payment methods. In step 90, the user terminal 1 accepts selection of a payment method. In the present exemplary embodiment, a description is made as to the case where the payment method by account transfer is selected.

Then, the user terminal 1 transmits to the relay device 4 transfer instruction information including payment type selection information indicating selection of the payment type, information indicating the selection of payment method by account transfer, and transfer information accepted in step 20, and the financial institution ID 113 and the personal bank account informational inputted and accepted in step 10. When the selection of payment only to the tax receiving agent is accepted in step 20, the transfer instruction information includes payment type selection information of the payment type indicating the payment to the tax receiving agent, information indicating the selection of the payment method by account transfer, and the financial institution ID 113 and the personal bank account informational inputted and accepted in step 10.

Here, when the selection of payment to the payment request institution is included in the payment type, the transfer instruction information may be transferred from the payment request institution 3 to the relay device 4. In this case, steps 60 through 90 may be conducted as follows. In step 60, a payment request number 354 of the selected payment request information, information indicating the selection of the payment method by account transfer, the financial institution ID 113 and the personal bank account information are sent to the payment request institution device 3. In step 80, the payment request institution device 3 may transmit to the relay device 4 transfer instruction information including information indicating the selection of the payment method by account transfer, the payment request information picked up in step 75, the financial institution ID 113 and the personal bank account information stored in the IC card, and a payment request institution ID 431 that is an identifier that identifies the payment request institution. Step 85 and 90 are omitted.

In step 91, the relay device 4 receives the transfer instruction information. In step 92, the relay device 4 judges whether the payment request institution ID 431 is included in the received transfer instruction information. When the payment request institution ID 431 is not included, in other words, in the case of the transfer instruction information transmitted when the selection of payment only to the tax receiving agent is accepted in step 90, the process proceeds to step 93.

In step 93, the relay device 4 judges whether the transfer instruction information includes the payment type selection information indicating that the payment to the tax receiving agent is selected. When such an information is not included, the relay device 4 sends in step 94 request rejection information to the user terminal 1. In step 95, the user terminal 1 receives the request rejection information, and ends the process. In step 93, when it is judged that the payment type selection information indicating that the payment to the tax receiving agent is selected, the process proceeds to step 100.

In step 92, the relay device 4 proceeds to step 98 when the payment request institution ID 431 is included in the transfer instruction information. In step 98, the relay device 4 retrieves the payment request institution ID 431 from a payment request institution DB 43, and judges whether there is a payment request institution ID corresponding to the received payment request institution ID 431. If negative, the relay device 4 proceeds to step 94. If positive, the relay device 4 proceeds to step 100. Here, when the payment request institution ID 431 is an address, such as, for example, an e-mail address, IP address, etc. of the payment request institution with which communication can be made with the payment request institution, in step 98, the relay device 4 may transmit confirmation information to affirm the validity of the transfer information to the payment request institution device 3 of the payment request institution that is identified by the payment request institution ID 431 and can be communicated, and may receive information that verifies the validity of the transfer information from the payment request institution device 3. Step 98 is a step to judge whether the transfer processing indicated by the received transfer instruction information is possible.

In step 100, the relay device 4 creates a screen of a list of personal bank account information included in the transfer instruction information, and transmits the same to the user terminal 1. In step 105, the user terminal 1 receives and displays the screen of the list of personal bank account information. In step 110, the user terminal 1 accepts designation of personal bank account information of an account which is the user's transfer source account selected from the list of personal bank account information, and transmits the same to the relay device 4.

In step 115, the relay device 4 accepts the personal bank account information designated as the user's transfer source account. In step 116, the relay device 4 judges whether the selection of the payment to the tax receiving agent is included in the payment type selection information of the transfer instruction information. The process proceeds to step 120 when the payment to the tax receiving agent has not been selected. The process proceeds to step 195 when the selection of the payment to the tax receiving agent is included.

In step 195, the relay device 4 creates a screen for accepting an input of the payment request number that identifies a payment request that the tax receiving agent issued to the user, and transmits the same to the user terminal 1. In step 196, the user terminal 1 receives and displays the payment request number input receiving screen, and accepts an input of the payment request number from the user. In step 197, the user terminal 1 transmits the payment request number to the relay device 4. In step 198, the relay device receives the payment request number and transmits the same to the tax receiving agent device 6. In step 200, the tax receiving agent device 6 receives the payment request number. In step 205, the tax receiving agent device 6 retrieves a payment request number 631 from a tax receiving agent payment request information DB 63, and extracts payment request information with the payment request number 631 that matches with the received payment request number. In step 215, the tax receiving agent device 6 transmits to the relay device 4 the payment request number 631, an amount 633, and tax receiving agent payment request information including a transfer destination account 634 that the tax receiving agent designates as a transfer destination account. In step 220, the relay device 4 receives the tax receiving agent payment request information.

In step 120, the relay device 4 creates a payment contents confirming screen. The payment contents confirming screen may be in any form with which the user can verify the contents of the payment request information for which the user makes payments. For example, in the case of payment to the payment request institution, the payment contents confirming screen may include a payment request institution's name 432 of the payment request institution, a financial institution ID, personal bank account information, and an amount 354. In the case of payment to the tax receiving agent, the screen may include the payment request number 631 and an amount 633. In step 125, the user terminal 1 receives and displays the payment contents confirming screen. In step 130, the user terminal 1 accepts an input of a password for fund transfer from the user, and transmits the password for fund transfer to the relay device 4. Here, the password for fund transfer is a password stored in the financial institution device 5, which is used to confirm the validity of the user.

In step 135, the relay device 4 receives the password for fund transfer, and transmits account transfer processing request information to the financial institution device 5 identified by the financial institution ID 113. When payment to the payment request institution has been selected as the payment type, the account transfer processing request information includes the password for fund transfer, personal bank account information, a payment request number 353, a transfer destination account 356, and an amount 355. When payment to the tax receiving agent has been selected, the account transfer processing request information includes the password for fund transfer, personal bank account information, a payment request number 631, an amount 633, and a transfer destination account 634.

In step 140, the financial institution device 5 receives the account transfer processing request information, and retrieves an account number corresponding to the account number 116 included in the personal bank account information in the account transfer processing request information from among the account numbers 531 of the customer management DB 53, extracts client management information, and judges whether a password for fund transfer 533 matches with the received password for fund transfer. When they do not match, the process proceeds to step 142. When they match, the process proceeds to step 145. In step 142, the financial institution device 5 transmits an instruction to accept an input of a password for fund transfer to the relay device 4 again, and the relay device 4 transmits the instruction to the user terminal 1. Steps 130-142 are repeated, and when they are repeated a predetermined time, the financial institution device 5 ends the process, and transmits a notification to that effect to the user terminal 1 through the relay device 4. In step 145, the financial institution device 5 executes an account transfer processing, and sends the processing result to the relay device 4. The account transfer processing is a processing to transfer from the account identified by the account number 114 the amount 355 to the transfer destination account 356, and the amount 633 to the transfer destination account 634. Then, the financial institution device 5 transmits to the relay device 4 processing result information that includes the payment request number 354 and/or the payment request number 631 and indicates that the account transfer processing has been executed.

In step 150, the relay device 4 receives the processing result information. In step 153, the relay device 4 judges whether the processing result information includes the payment request number 354 that is the payment request number of the payment request institution. When the payment request number 354 is included, it is assumed that the payment to the payment request institution has been made, and the process proceeds to step 155. When the payment request number 354 is not included, the process proceeds to step 161.

In step 155, the relay device 4 transmits the payment request number 354 to the payment request institution device 3. In step 160, the payment request institution device 3 receives the payment request number 354, extracts payment request information identified by the payment request number 354 from the payment request information list DB 35, and stores the payment request information in a transaction DB 37. The transaction DB 37 is a data base that stores results of the transfer processing. A payment request information institution use ID 351 in the payment request information is stored in a payment request institution use ID entry field 371, a name 352 in a name entry field 372, a payment request number 354 in a payment request number entry field 373. Moreover, a transaction contents entry filed 374 stores the payment request type 353 and contents of the processing. A transaction date/time entry field 375 stores data indicating the date and time of the transaction. The date and time of the transaction may be the time when the financial institution device 5 processed the transfer, and such data can be sent and stored. Alternatively, the date and time of the transaction may be the date and time when the payment request institution device 3 received the processing result, and such data can be stored.

In step 161, the relay device 4 judges whether the payment request number 631 that is a payment request number of the tax receiving agent is included in the processing result information. When the payment request number 631 is included, it is assumed that the payment has been made to the tax receiving agent, and the process proceeds to step 240. The process proceeds to step 165 when the payment request number 631 is not included. In step 240, the tax receiving agent device 6 receives the processing result information, and stores the payment request number 354 and the amount 633 included in the processing result information in a payment request number entry field 642 and an amount entry field 643 of a transaction DB 64 that stores transaction results executed.

In step 165, the relay device 4 sends the processing result information to the user terminal 1.

In step 170, the user terminal 1 receives the processing result information, and displays in the display device 14.

Processing in step 270 and thereafter are described with reference to am exemplary embodiment 2.

### Exemplary Embodiment 2

Exemplary embodiment 2 describes a method, an apparatus and a system that allow users to receive prescribed service when the users are registered in a member DB 45 of the relay device DB 41, and further allow users to receive prescribed service in addition to payment processing services relating to payment request information when the users who want to make payments for payment request information are those of the registered users.

In step 91, the relay device 4 receives processing request information from the user terminal 1 or the payment request institution device 3. The processing request information may be transfer instruction information received in step 91 of the exemplary embodiment, and may be other information. In step 250, the relay device 4 judges whether a payment request institution ID 431 is included in the processing request information. When it is included, in other words, when transfer instruction information is included in the processing request information, the same processing conducted in steps 98-165 of the exemplary embodiment is conducted.

When a payment request institution ID 431 is not included, the process proceeds to step 280. In step 280, the relay device 4 judges whether a relay device member ID 111 that is stored in the user's IC card is included in the processing request information. When a relay device member ID 111 is included, the relay device 4 searches a relay device member ID entry field 452 in the member DB 45, and judges whether there is a corresponding relay device member ID. If positive, the relay device 4 determines that the user is a member, and processes in step 300 the service prescribed in advance for the member. If, in step 280, it is determined that a relay device member ID 111 is not included, or there is no corresponding relay device member ID, the relay device 4 rejects the processing request.

In step 270, the relay device 4 judges whether a relay device member ID 111 stored in the user's IC card is included in the processing request information. When a relay device member ID 111 is included, the relay device 4 searches the relay device member ID entry field 452 in the member DB 45, and judges whether there is a corresponding relay device member ID.

If positive, the relay device 4 determines that the user is a member, and processes in step 300 the service prescribed in advance for the member. If, in step 270, it is determined that a relay device member ID 111 is not included, or there is no corresponding relay device member ID, the relay device 4 ends the processing in step 275.

The present invention is applicable in fund transfer and payment transactions executed through telecommunication lines.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An account transfer process instructing method to be used with a system including at least a payment request institution device of a payment request institution that requests a user to make a payment of a billed amount, a user terminal that is used by the user, an authentication device that authenticates the user by using a user identifier transmitted from the user terminal, and transmits information inputted through the user terminal to the payment request institution device, and a relay device that is connected to a financial institution device that executes a fund transfer processing to transfer the billed amount from a user's account maintained by the user to a payment request institution account maintained by the payment request institution, the method wherein
the user terminal transmits the user identifier that identifies the user to the authentication device;
the authentication device authenticates the user by using the user identifier;
the authentication device transmits the user identifier to the payment request institution device, when the user is authenticated as a right user;
the payment request institution device retrieves payment request information for the user that is indicated by the user identifier received, the payment request information including the billed amount, a payment request institution identifier that identifies the payment request institution, and payment request institution account information that identifies the payment request institution account;
the relay device accepts the payment request information and transfer instruction information that instructs a payment by an account transfer processing for the payment request information, wherein the transfer instruction information includes user account information that identifies the user's account that is selected as a payment transfer source for the payment request information based on the payment request information retrieved by the payment request institution device and presented to the user;
the relay device determines, by using the payment request institution identifier included in the payment request information, as to whether a transfer processing indicated by the transfer instruction information is possible; and
the relay device transmits to the financial institution device account transfer process instructing information that instructs to transfer the billed amount from the user's account to the payment request institution account when the transfer processing is possible.

2. An account transfer process instructing method according to claim 1, wherein
the payment request institution device transmits the payment request information retrieved to the user terminal,
the user terminal transmits to the relay device payment request information selected by the user from among the payment request information and the transfer instruction information including the user account information selected by the user, and
the relay device judges based on the payment request institution identifier included in the payment request information transmitted as to whether the transfer processing is possible.

3. An account transfer process instructing method according to claim 1, wherein
the relay device is connectable to a storage device that stores in advance identifiers that identify payment request institutions that can be handled by the relay device, and
the relay device judges as to whether the transfer processing is possible by comparing the identifiers and the payment request institution identifier received.

4. An account transfer process instructing method according to claim 1, wherein
the relay device is connectable to a storage device that stores in advance identifiers that identify payment request institutions that can be handled by the relay device, and
the relay device judges as to whether the transfer processing is possible by searching the identifiers stored in the storage device, determining as to whether any one of the identifiers matches with the payment request institution identifier received, and judging that the transfer processing is possible when the payment request institution identifier received matches with one of the identifiers.

5. An account transfer process instructing method to be used with a relay device that is connected to an authentication device that authenticates a user as an authorized user, a user terminal that is used by the user who makes a payment of a billed amount requested by a payment request institution and a financial institution device that executes a fund transfer processing to transfer the billed amount from a user's account maintained by the user to a payment request institution account maintained by the payment request institution, wherein the relay device transmits an instruction to perform the fund transfer processing to the financial institution device, the account transfer process instructing method comprising the steps of:
receiving transfer instruction information including user account information that identifies the user's account that is selected as a payment transfer source by the user who is authenticated by the authentication device, a payment request institution identifier that identifies the payment request institution, and payment request institution account information that identifies the payment request institution account;
judging by using the payment request institution identifier as to whether a transfer processing indicated by the transfer instruction information is possible; and
transmitting to the financial institution device account transfer process instructing information that instructs to transfer the billed amount from the user's account to the payment request institution account when the transfer processing is possible.

6. An account transfer process instructing method according to claim 5, wherein
the relay device is connectable to a storage device that stores in advance identifiers that identify payment request institutions that can be handled by the relay device, and
a judgment as to whether the transfer processing is possible is made by comparing the identifiers and the payment request institution identifier received.

7. An account transfer process instructing method according to claim 5, wherein
the relay device is connectable to a storage device that stores in advance identifiers that identify payment request institutions that can be handled by the relay device,
a judgment as to whether the transfer processing is possible is made by searching the identifiers stored in the storage device, and determining as to whether any one of the identifiers matches with the payment request institution identifier received, and
a judgment is made that the transfer processing is possible when the payment request institution identifier received matches with one of the identifiers.

8. An account transfer process instructing method according to claim 5, wherein
the relay device is connected to a payment request institution device of the payment request institution, and
the relay device judges as to whether the transfer processing is possible by inquiring the payment request institution device of the payment request institution identified by the payment request institution identifier about authenticity of the payment request information.

9. An account transfer process instructing method according to claim 5, wherein
the relay device is connected to a payment request institution device of the payment request institution, and receives the transfer instruction information from the payment request institution device.

10. An account transfer process instructing method according to claim 5, wherein the relay device is connected to a payment request institution device of the payment request institution, and when the relay device receives from the financial institution device a notification indicating that the transfer processing ended, the relay device notifies the payment request institution device that the transfer processing ended.

11. An account transfer process instructing apparatus comprising:
a relay device that is connected to an authentication device that authenticates a user as an authorized user, a user terminal that is used by the user who makes a payment of a billed amount requested by a payment request institution and a financial institution device that executes a transfer processing to transfer the billed amount from a user's account maintained by the user to a payment request institution account maintained by the payment request institution, wherein the account transfer process instructing apparatus transmits an instruction to perform the transfer processing to the financial institution device;
a receiving device that receives transfer instruction information including user account information that identifies the user's account that is selected as a payment transfer source by the user who is authenticated by the authentication device, a payment request institution identifier that identifies the payment request institution, and payment request institution account information that identifies the payment request institution account;
a judging device that makes a judgment by using the payment request institution identifier as to whether a transfer processing indicated by the transfer instruction information is possible; and
a transmission device that transmits to the financial institution device account transfer process instructing information that instructs to transfer the billed amount from the user's account to the payment request institution account when the transfer processing is possible.

12. An account transfer process instructing apparatus according to claim 11, wherein
the relay device is connectable to a storage device that stores in advance identifiers that identify payment request institutions that can be handled by the relay device, and
the judging device makes the judgment by comparing the identifiers and the payment request institution identifier received.

13. An account transfer process instructing apparatus according to claim 11, wherein
the relay device is connectable to a storage device that stores in advance identifiers that identify payment request institutions that can be handled by the relay device,
the judgment device searches the identifiers stored in the storage device, and determines as to whether any one of the identifiers matches with the payment request institution identifier received, and makes a judgment indicating that the transfer processing is possible when the payment request institution identifier received matches with one of the identifiers.

14. An account transfer process instructing apparatus according to claim 11, wherein
the relay device is connected to a payment request institution device of the payment request institution, and
the judging device judges as to whether the transfer processing is possible by inquiring the payment request institution device of the payment request institution identified by the payment request institution identifier about authenticity of the payment request information.

15. An account transfer process instructing apparatus according to claim 11, wherein
the relay device is connected to a payment request institution device of the payment request institution, and receiving device receives the transfer instruction information from the payment request institution device.

16. An account transfer process instructing apparatus according to claim 11, wherein
the relay device is connected to a payment request institution device of the payment request institution, and
the relay device is equipped with a receiving device that receives the financial institution device a completion end notification indicating that the transfer processing ended, and a notification device that notifies, upon receiving the completion end notification, the payment request institution device that the transfer processing ended.

17. An account transfer process instructing system comprising:
an authentication device that authenticates users as authorized users;
at least one user terminal that is used by each of the users who makes a payment of a billed amount requested by a payment request institution;
at least one financial institution device that executes a transfer processing to transfer the billed amount from a user's account maintained by the user to a payment request institution account maintained by the payment request institution;
a relay device that is connected to the authentication device, the at least one user terminal and the at least one financial institution device via a communications network, wherein the relay device includes
a receiving device that receives transfer instruction information including user account information that identifies the user's account that is selected as a payment transfer source by the user who is authenticated by the authentication device, a payment request institution identifier that identifies the payment request institution, and payment request institution account information that identifies the payment request institution account,
a judging device that makes a judgment by using the payment request institution identifier as to whether a transfer processing indicated by the transfer instruction information is possible, and
a transmission device that transmits to the financial institution device account transfer process instructing information that instructs to transfer the billed amount from the user's account to the payment request institution account when the transfer processing is possible.

18. An account transfer process instructing system according to claim 17, wherein
the relay device is connected to a payment request institution device of the payment request institution, and
the judging device makes the judgment by comparing the identifiers and the payment request institution identifier received.

19. An account transfer process instructing method, comprising:
transmitting from a user terminal a user identifier that identifies a user to an authentication device;
authenticating the user by using the user identifier at the authentication device;
transmitting the user identifier from the authentication device to a payment request institution device, when the user is authenticated as a right user;
retrieving at the payment request institution device payment request information for the user that is indicated by the user identifier received, wherein the payment request information includes a billed amount, a payment request institution identifier that identifies the payment request institution, and payment request institution account information that identifies a payment request institution account;
receiving at a relay device the payment request information and transfer instruction information that instructs a payment by an account transfer processing for the payment request information, wherein the transfer instruction information includes user account information that identifies a user's account that is selected as a payment transfer source for the payment request information based on the payment request information retrieved at the payment request institution device;
judging by the relay device, by using the payment request institution identifier included in the payment request information, as to whether a transfer processing indicated by the transfer instruction information is possible; and
transmitting from the relay device to the financial institution device account transfer process instructing information that instructs to transfer the billed amount from the user's account to the payment request institution account when the transfer processing is possible.

20. An account transfer process instructing method according to claim 5, wherein
the payment request institution device transmits the payment request information retrieved to the user terminal,
the user terminal transmits to the relay device payment request information selected from among the payment request information and the transfer instruction information including the user account information selected, and
the relay device judges based on the payment request institution identifier included in the payment request information transmitted as to whether the transfer processing is possible.
